(19) United States
(12) Patent Application Publication
(10) Pub. No.: US 2015/0038025 A1
(43) Pub. Date: Feb. 5, 2015

(54) ELECTRICAL TERMINAL ASSEMBLY

(71) Applicant: Lear Corporation, Southfield, MI (US)

(72) Inventors: Mark Anthony Mueller, Fenton, MI (US); David A. Hein, Sterling Heights, MI (US); Aric Henderson Anglin, Rives Junction, MI (US); Mary Mueller, Fenton, MI (US)

(21) Appl. No.: 14/324,701

(22) Filed: Jul. 7, 2014

Related U.S. Application Data
(60) Provisional application No. 61/861,083, filed on Aug. 1, 2013.

(51) Int. Cl. H01R 4/02; H01R 43/02; H01R 43/048; H01R 13/04

(52) U.S. Cl. CPC H01R 4/023; H01R 13/04; H01R 43/02; H01R 43/048
USPC 439/874; 29/860

(57) ABSTRACT

An electrical terminal assembly is provided with at least one blade having a distal end that is sized to be received within an electrical outlet. One of a lug and a pair of crimp tabs with distal ends is provided on a proximal end of the at least one blade. A wire is in electrical communication with a vehicle charger. The wire is welded to the lug or received between the pair of crimp tabs with the distal ends of the crimp tabs deformed centrally within the crimp tabs to press the wire against the proximal end of the at least one blade, with the wire welded to the pair of crimp tabs.

### CROSS-REFERENCE TO RELATED APPLICATIONS

This application claims the benefit of U.S. provisional application Ser. No. 61/861,083 filed Aug. 1, 2013, the disclosure of which is hereby incorporated in its entirety by reference herein.

### TECHNICAL FIELD

Various embodiments relate to electrical terminal assemblies.

### BACKGROUND

Standard electric vehicle supply equipment (EVSE) utilizes a standard off-the-shelf plug assembly for receiving power from a wall outlet. Terminals in the plug assembly are attached to wires using a standard double or B-Crimp crimping process.

### SUMMARY

According to at least one embodiment, an electrical terminal assembly is provided with at least one blade having a distal end that is sized to be received within an electrical outlet. One of a lug and a pair of crimp tabs with distal ends is provided on a proximal end of the at least one blade. A wire is in electrical communication with a vehicle charger. The wire is welded to the lug or received between the pair of crimp tabs with the distal ends of the crimp tabs deformed centrally within the crimp tabs to press the wire against the proximal end of the at least one blade, with the wire welded to the pair of crimp tabs.

According to at least another embodiment, an electrical terminal assembly is provided with at least two blades, each having a distal end sized to be received within an electrical outlet. At least two pairs of crimp tabs are each provided with distal ends provided on a proximal end of one of the at least two blades. A pair of wires is in electrical communication with a vehicle charger. The pair of wires is each received between one of the pair of crimp tabs. The distal ends of the crimp tabs are deformed centrally within the pair of crimp tabs to press the corresponding wire against the proximal end of the corresponding blade. The pair of wires is each welded to the corresponding pair of crimp tabs.

A method for manufacturing an electrical terminal assembly according to at least one embodiment forms at least one blade with a distal end sized to be received within an electrical outlet. One of a lug and a pair of crimp tabs with distal ends is formed on a proximal end of the at least one blade. A wire is provided in engagement with the lug or between the pair of crimp tabs. The wire is welded to the lug or the pair of crimp tabs. The wire is provided in electrical communication with a vehicle charger.

According to at least another embodiment, an electrical terminal assembly is manufactured by forming at least one blade with a distal end sized to be received within an electrical outlet. One of a lug and a pair of crimp tabs with distal ends is formed on a proximal end of the at least one blade. A wire is provided in engagement with the lug or between the pair of crimp tabs. The wire is welded to the lug or the pair of crimp tabs. The wire is provided in electrical communication with a vehicle charger.

### BRIEF DESCRIPTION OF THE DRAWINGS

FIG. 1 is a perspective view of a connector assembly according to an embodiment illustrated in cooperation with a vehicle and a power supply;

FIG. 2 is a perspective view of a connector assembly according to an embodiment, illustrated partially disassembled;

FIG. 3 is a perspective view of the connector assembly of FIG. 2, illustrated assembled with a pair of wires;

FIG. 4 is a perspective view of a blade of a connector assembly according to another embodiment;

FIG. 5 is a perspective view of the blade of the connector assembly of FIG. 4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

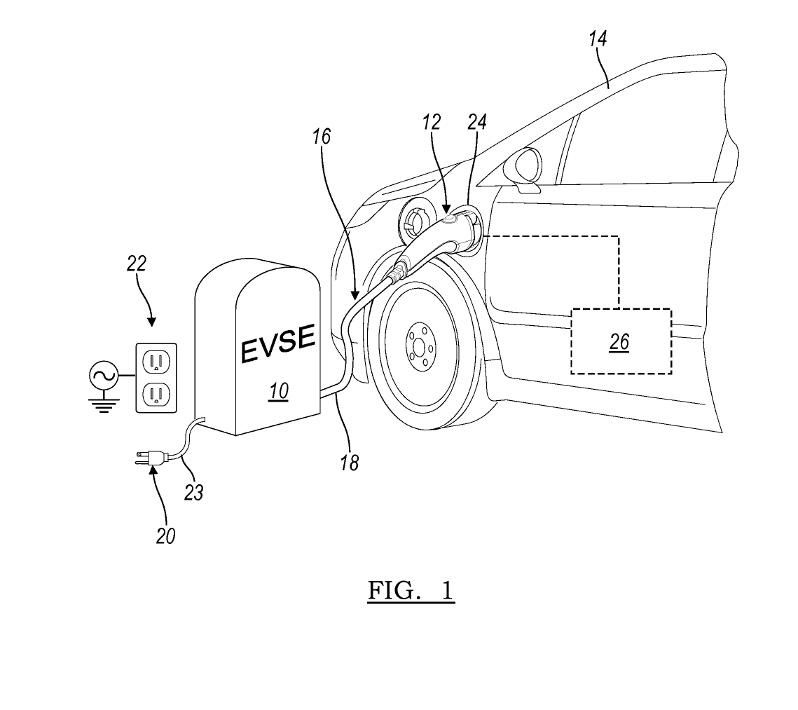

With reference to FIG. 1, an electric vehicle supply equipment (EVSE) is illustrated in accordance with an embodiment, and referenced generally by numeral 10. The EVSE 10 includes a vehicle connector assembly 12 for facilitating electric charging of a vehicle 14. The vehicle connector assembly 12 is included in a cordset assembly 16, according to one or more embodiments. The cordset assembly 16 includes a charging cable 18 extending between the EVSE 10 and the vehicle connector assembly 12.

The EVSE 10 includes a power supply connector assembly 20 for connecting to an external power supply 22 for receiving electrical energy. The power supply connector assembly 20 includes a cordset 23 connected to the EVSE 10. The external power supply 22 represents an alternating current (AC) electrical power supply, such as a standard residential power circuit. The EVSE 10 may be configured to monitor electrical energy passing through the cable 18 during charging. The cordset assembly 16 may be configured to be portable (as shown in FIG. 1) or fixed to a charging station (not shown).

The vehicle connector assembly 12 attaches to a “plug-in” vehicle 14, such as a hybrid electric vehicle, a battery electric vehicle, or the like, for supplying electrical energy to the vehicle 14. The vehicle 14 includes a vehicle charging receptacle 24 that is connected to a battery 26 for receiving and storing electrical energy. The vehicle charging receptacle 24 is mounted to be externally accessible from the vehicle 14. The vehicle charging receptacle 24 receives the vehicle connector assembly 12. The battery 26 is electrically connected to the vehicle charging receptacle 24 for storing electrical power. The vehicle 14 may also include a converter (not shown) for converting AC to DC electrical power for storage in the battery 26. The vehicle 14 may be an electric vehicle, or any suitable vehicle that receives external electric power.

Prior art EVSEs utilize a standard off-the-shelf power supply connector assembly or plug assembly. The prior art plug assembly includes terminals that are attached to wires using a standard double crimp or B-Crimp crimping process. Under conditions wherein the prior art plug assembly is connected to a worn receptacle or in an area with limited air flow, the plug assembly can heat to the point where permanent degradation of the plug assembly can occur. The permanent degradation is caused by the loosening of the crimp or by oxidation of the metals in the crimp interface. The degradation of the crimp causes an increase in the resistance of the terminal crimp interface. The increased resistance causes the plug assembly to run hotter and therefore, degrade further.

Some alternatives to achieving a better crimp interface include: 1) Soldering the wire at the crimp interface; 2) Using more expensive materials for metals in the crimp; and 3) welding the wire to the terminal. Welding provides a significant performance advantage without an increase in material cost. Often, a prior art EVSE is required to be discarded if the plug assembly degrades. The EVSE is currently a costly device. The current life of the prior art plug assembly depends highly on the outlets being used, but, could be less than 1 year. Eliminating the failure of the plug assembly eliminates a significant volume of the plug assembly failures.

According to one embodiment, a terminal is crimped to the wire. Then the terminal is welded to a wire. According to another embodiment, a terminal is provided with a flat blade. Then the terminal is welded to a wire. According to further embodiments, the terminal is welded by resistance, sonic or vibration welding. The welding or the terminals allow the power cord to operate at higher temperature and at higher efficiencies.

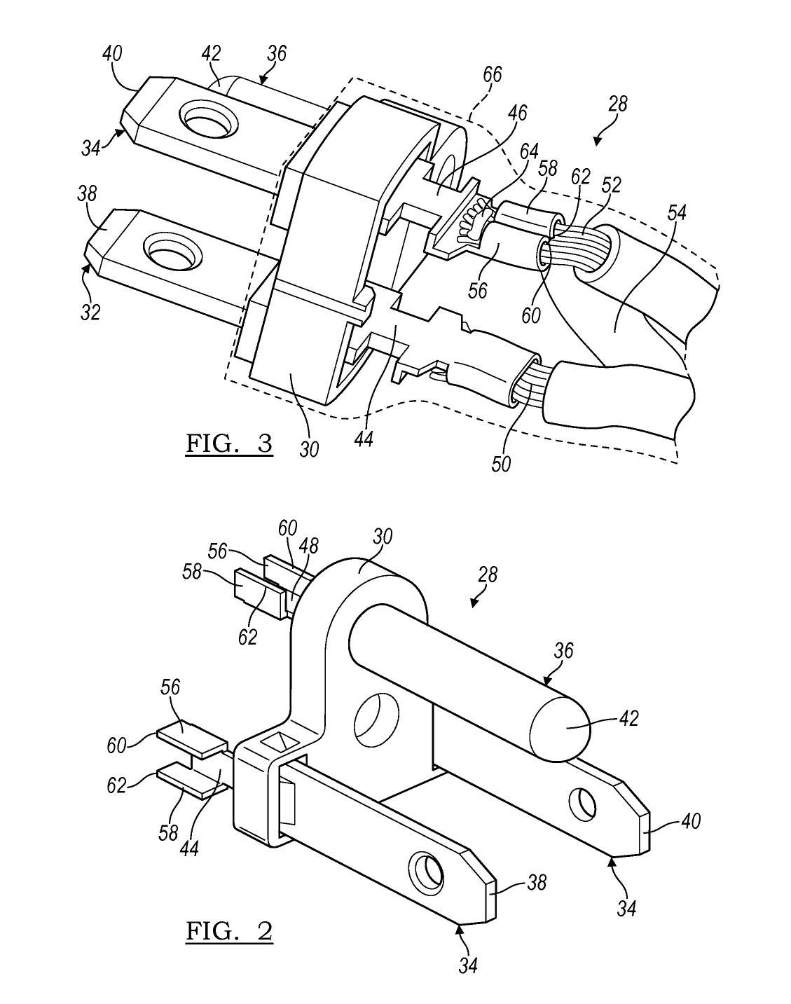

Referring now to FIGS. 2 and 3, the power supply connector assembly 20 is illustrated partially disassembled according to an embodiment revealing an electrical terminal assembly 28. The connector assembly 20 includes a substrate 30 for supporting a plurality of blades 32, 34, 36. The blades 32, 34, 36 each include a distal end 38, 40, 42 that extend from the substrate 30 and is sized to be received within an electrical outlet of the external power supply 22. Each of the blades 32, 34, 36 include a proximal end 44, 46, 48 that extends within the power supply connector assembly 20 for electrical connection to a wire 50, 52, 54 of the cordset 23.

Each of the blades 32, 34, 36, includes a pair of crimp tabs 56, 58 each with a distal end 60, 62 extending from the respective blade 32, 34, 36. Each wire 50, 52, 54 is received between a pair of crimp tabs 56, 58 and then the distal ends 60, 62 are deformed centrally within the crimp tabs 56, 58 as illustrated in FIG. 3 to press the wires 50, 52, 54 against the proximal ends 44, 46, 48 of the blades 32, 34, 36. The dual crimp tab configuration is formed in the shape similar to a capital letter ‘B’ and is often referred to as a B-crimp.

To further enhance this connection, the wires 50, 52, 54 are welded to the crimp tabs 56, 58 by weld 64. Alternatively, the wires 50, 52, 54 may be welded to the blades 32, 34, 36 prior to the crimping process. The wires 50, 52, 54 may be welded to the blades 32, 34, 36 by resistance welding, sonic welding, vibration welding, soldering, or the like. Once assembled, a cord 66 is molded over the substrate 30, the proximal ends 44, 46, 48 of the blades 32, 34, 36, and the wires 50, 52, 54.

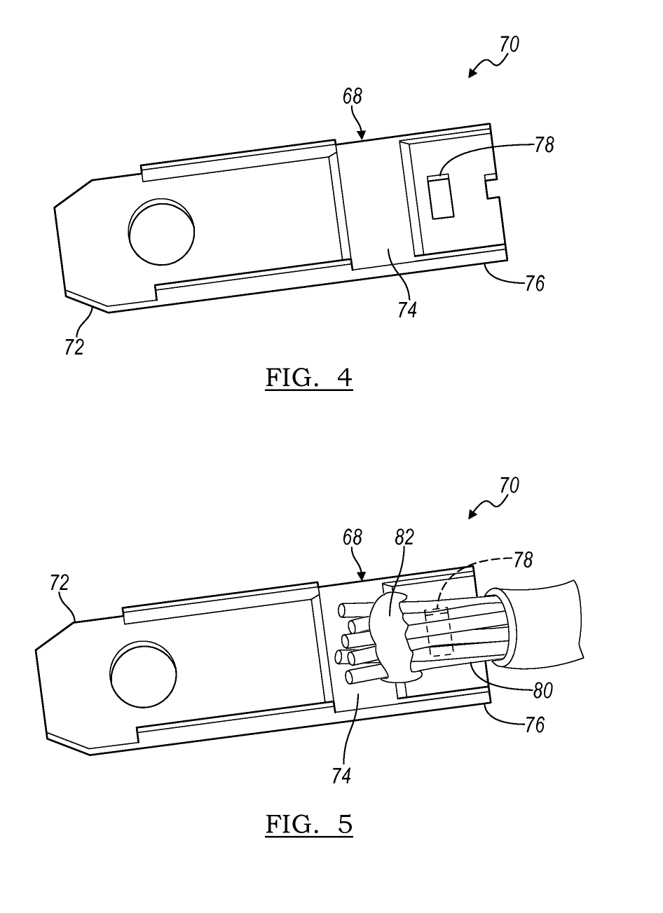

FIG. 4 illustrates a blade 68 for an electrical terminal assembly 70 according to another embodiment of the power supply connector assembly 20. The blade 68 has a distal end 72 sized to be received in an electrical outlet. An intermediate region 74 of the blade 68 is sized to be mounted in a substrate 30. A proximal end 76 of the blade 68 is provided with a lug 78 for mounting a wire 80 as illustrated in FIG. 5. The wire 80 is welded to the lug 78 by a weld 82 to fasten the connection. Alternatively, the wire 80 can be welded to the lug 78 by resistance welding, sonic welding, vibration welding, soldering, or the like.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electrical terminal assembly comprising:
at least one blade having a distal end sized to be received within an electrical outlet;
one of a lug and a pair of crimp tabs with distal ends provided on a proximal end of the at least one blade; and
a wire in electrical communication with a vehicle charger, the wire being welded to the lug, or the wire being received between the pair of crimp tabs with the distal ends of the crimp tabs deformed centrally within the crimp tabs to retain the wire against the proximal end of the at least one blade and welded to the pair of crimp tabs.

2. The electrical terminal assembly of claim 1 further comprising a lug provided on the proximal end of the at least one blade.

3. The electrical terminal assembly of claim 2 wherein the wire is engaged to the lug.

4. The electrical terminal assembly of claim 3 wherein the wire is welded to the lug.

5. The electrical terminal assembly of claim 4 further comprising weld adhering the wire to the lug.

6. The electrical terminal assembly of claim 1 further comprising a pair of crimp tabs with distal ends provided on the proximal end of the at least one blade.

7. The electrical terminal assembly of claim 6 wherein the wire is retained within a B-crimp.

8. The electrical terminal assembly of claim 6 wherein the wire is welded to the pair of crimp tabs.

9. The electrical terminal assembly of claim 6 wherein the wire is received between the pair of crimp tabs with the distal ends of the crimp tabs deformed centrally within the pair of crimp tabs to press the wire against the proximal end of the at least one blade.

10. The electrical terminal assembly of claim 9 wherein the deformed pair of crimp tabs form a shape similar to capital letter ‘B’.

11. The electrical terminal assembly of claim 9 further comprising weld adhering the wire to the pair of crimp tabs.

12. An electric vehicle supply equipment comprising at least two electrical terminal assemblies according to claim 1.

13. An electrical terminal assembly comprising:
at least two blades, each having a distal end sized to be received within an electrical outlet;
at least two pairs of crimp tabs, each pair with distal ends provided on a proximal end of one of the at least two blades; and
a pair of wires in electrical communication with a vehicle charger, the pair of wires being each received between one of the pair of crimp tabs with the distal ends of the crimp tabs deformed centrally within the pair of crimp tabs to press the corresponding wire against the proximal end of the corresponding blade, the pair of wires being each welded to the corresponding pair of crimp tabs.

14. A method for manufacturing an electrical terminal assembly, the method comprising:
forming at least one blade with a distal end sized to be received within an electrical outlet;
forming one of a lug and a pair of crimp tabs with distal ends disposed centrally within proximal ends of the pair of crimp tabs on a proximal end of the at least one blade;
providing a wire in engagement with the lug or between the pair of crimp tabs;
welding the wire to the lug or the pair of crimp tabs; and
providing the wire in electrical communication with a vehicle charger.

15. The method for manufacturing an electrical terminal assembly of claim 14, the method further comprising a step of deforming the pair of crimp tabs so that the distal ends are disposed centrally within the crimp tabs thereby pressing the wire against the proximal end of the at least one blade, if the wire is in engagement between the pair of crimp tabs.

16. The method for manufacturing an electrical terminal assembly of claim 14, the method further comprising a step of resistance welding the wire to the lug or the pair of crimp tabs.

17. The method for manufacturing an electrical terminal assembly of claim 14, the method further comprising a step of sonic welding the wire to the lug or the pair of crimp tabs.

18. The method for manufacturing an electrical terminal assembly of claim 14, the method further comprising a step of vibration welding the wire to the lug or the pair of crimp tabs.

19. The method for manufacturing an electrical terminal assembly of claim 14, the method further comprising a step of over-molding a cord over the wire and the proximal end of the at least one blade.

20. An electrical terminal assembly manufactured from the method of claim 14.
